(19) United States
(12) Patent Application Publication
(10) Pub. No.: US 2007/0046967 A1
(43) Pub. Date: Mar. 1, 2007

(54) Printer clients management system

(75) Inventor: Dahmane Bounar, Dublin, CA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA SYSTEMS LABORATORY, INC.

(21) Appl. No.: 11/214,972

(22) Filed: Aug. 31, 2005

(51) Int. Cl. G06F 3/12

(52) U.S. Cl. 358/1.13; 358/1.9

(57) ABSTRACT

The present application relates to a printing system in which a print client for a specified printer in the printing system can be easily identified.

### DESCRIPTION

1. Field

The present invention relates to a printing system.

2. Introduction

By utilizing a printing system in which several printers and several personal computers (PC) are connected via a network, an user can print a document data according to an user's instruction from his/her PC in an office, a house or the like.

Such printing system is preferable because the user can select the printer easily depending on the user's purpose of the print (e.g., black and white or color prints, high speed or low speed and the like). However, the printing system typically exhibits certain drawbacks as the number of the printers increases in the office. For example, when new version of a printer driver for the printer and/or a new version of an operating system (OS) is introduced to the printing system and an old version of the printer driver or the OS in the client computer should be replaced with the new version, it takes long time to find what client computer in the printing system includes old version of the printer driver or the OS.

Therefore, it is desirable that it is easy to find what printer driver and/or OS is installed in each client computer in the printing system.

### SUMMARY

According to various embodiments, the present teachings can provide a printing system. The printing system can comprise at least one printer, several client computers, a host computer and a display unit. In each of the several client computer, printer driver for the printer and the operating system can be installed. The printer, the client computers, the host computer and the display unit can be connected via a network. The host computer can collect printer driver information about what printer driver and/or operating system are installed in the client computers from the client computers. The host computer can decide which client computer is a print client for the printer based on the printer driver information. The display unit can display the print client for the printer.

### BRIEF DESCRIPTION OF THE DRAWINGS

FIG. 1 illustrates a block diagram of a printing system according to certain embodiments.

FIG. 2 illustrates a graphic display of a main screen including an icon for displaying the data of the print client according to certain embodiments.

FIG. 3 illustrates a graphic display of a printer selection window according to certain embodiments.

FIG. 4 illustrates a graphic display of a window showing the print client according to certain embodiments.

FIG. 5 illustrates a graphic display of a window showing the print client according to certain embodiments.

FIG. 6 illustrates a flowchart describing the collection of the device data according to certain embodiments.

FIG. 7 illustrates a flowchart describing the preparation and display of the data of the print client according to certain embodiments.

### DESCRIPTION OF CERTAIN EMBODIMENTS

A Printing System

In certain embodiments, a printing system can comprise one or several printer(s), one or several host computer(s) and one or several client computer(s). In certain embodiments, the printing system can further comprise one or several management computer(s). In certain embodiments, the printing system can further comprise a network which connects the printer with the host computer, the client computer and/or the management computer. In certain embodiments, the printing system can further comprise a display unit. In certain embodiments, the host computer, the client computer and/or the management computer can comprise the display unit.

Examples of the network consistent with certain embodiments of the invention include, but are not limited to, an internet, an intranet, a local area network (LAN) and a wide area network (WAN). The printer, the host computer, the client computer and/or the management computer can be connected with a wire or be connected with wireless by using radio frequency (RF) and/or infrared (IR) transmission.

In certain embodiments, an OS, an application software and a printer driver software can be installed into the client computer, the host computer and/or the management computer. Examples of the application software consistent with certain embodiments of the invention include, but are not limited to, a word processor software (e.g., Microsoft Word™ etc.), an image processing software (e.g., Adobe Photoshop™ etc.), a spread sheet software (e.g., Microsoft Excel™ etc) and a viewer software (e.g., Acrobat Reader™ etc.). The application software can produce a document data. The document data can include document, drawing, table, picture and/or photo and the like. In certain embodiments, the printer driver software can control the printer which corresponds to the printer driver. In certain embodiments, the printer driver software can produce a print job based on the document data. In certain embodiments, the printer driver software can control transmit of the print job from the client computer and/or the management computer to the host computer and/or the printer. In certain embodiments, the printer driver software can be installed in each of the client computer(s). In certain embodiments, the printer driver software can be installed in the host computer and the printer driver software can be downloaded from the host computer to the client computer via the network.

1) A Host Computer

In certain embodiments, the host computer can manage the entire printing system. In certain embodiments, the host computer can control data flow in the printing system. The host computer can collect and store a printer driver information from the client computer(s). Example of the host computer consistent with certain embodiments of the invention include, but are not limited to, a server computer and a PC. The host computer can comprise a processing unit, a transmit unit and a storing unit. The host computer can further comprise a display unit.

In certain embodiments, the processing unit of the host computer can control the entire host computer and/or the various units in the host computer. The processing unit can run various software including the OS, the application software and/or the printer driver software. The processing unit can process and/or calculate several data. Example of the processing unit consistent with certain embodiments of the invention include, but are not limited to, a central processing unit (CPU) or a micro processing unit (MPU) with a memory and a software necessary for the processing.

In certain embodiments, an application software for producing a polling request for requesting a printer driver information to the client computer and/or the management computer can be installed in the host computer. In certain embodiments, the processing unit can produce a polling request for requesting the printer driver information to the client computer and/or the management computer.

The printer driver information is the information about what printer driver and/or OS is installed in each client computer and/or the management computer in the printing system. The printer driver information can comprise at least the information about which the printer driver installed is for what printer. The printer driver information can comprise a version data of the printer driver and so on.

For instance, in the printing system comprising printers 1, 2 and 3 and client computers 1, 2 and 3, the following is one example of the printer driver information.

Client computer 1: OS, Windows 2000
a printer driver for the printer 1 (ver 1)

Client computer 2: OS, Windows XP
a printer driver for the printer 1 (ver. 2)
a printer driver for the printer 3 (ver. 1)

Client computer 3: OS, Windows XP
a printer driver for the printer 1 (ver. 1)
a printer driver for the printer 2 (ver. 2)
a printer driver for the printer 3 (ver. 1)

In certain embodiments, the processing unit can produce a polling request for requesting a device data to the client computer, the management computer and the printer. The device data is an information to specify a device (e.g., the client computer, the management computer and the printer) in the printing system. The device data can comprise at least one of a name of the device, a manufacturer of the device, a spec of the device and ID of the device.

In certain embodiments, the processing unit can decide which client computer and/or management computer is a print client for each of the printer in the printing system based on the printer driver information. In certain embodiments, the device data can be also used for deciding the print client by the processing unit. The device data can be referred when the processing unit decides the print client. In certain embodiments, based on the device data, the processing unit can tell whether or not the client computer is the print client. If a printer driver for a printer A is installed in a client computer X, the client computer X is a print client for the printer A. Therefore, in the above case, the processing unit can decide the print client for the printer A is the client computer X.

Following to the above example of the printer driver information, one example of the data of the print client is described below.

Print Client for Printer 1: Client computer 1, 2 and 3

Print Client for Printer 2: Client computer 3

Print Client for Printer 3: Client computer 2 and 3.

In certain embodiments, the processing unit can judge whether certain client computer or certain management computer is an active print client or not. If the client computer X has a print job for the printer A, the client computer X is an active print client for the printer A.

In certain embodiments, the storing unit of the host computer can store the print driver information, the data of the print client and/or the device data. In certain printing system, when a client computer transmits instruction to start printing by a printer for the first time, a printer driver for the printer can be downloaded automatically from the host computer to the client computer via a network. After downloading the printer driver to the client computer, the client computer can be a print client for the printer. If the printing system applies the above system such as Point and Print for Windows™, the storing unit can store the printer driver. When or after the printer driver is downloaded from the host computer to the client computer, the storing unit of the host computer can store the printer driver information which the printer driver is downloaded to the client computer. In such case, the host computer may not transmit a polling request to ask the printer driver information to the client computer for the printer driver.

The storing unit can store other data (e.g., the correct password and/or ID) and/or various software (including the OS, the application software and the printer driver software). Example of the storing unit consistent with certain embodiments of the invention include, but are not limited to, a hard disk, a memory (e.g., a random access memory (RAM) including NVRAM, M RAM, P RAM, Fe RAM, Flash RAM, and a read only memory (ROM)) and a removable data recording medium recorder/reader. Examples of a removable data recording medium for the removable data recording medium recorder/reader include, but are not limited to, a digital memory card, a compact disk (e.g., CD-R, CD-RW, etc.), and a digital versatile disk (e.g., DVD-R, DVD-RW, DVD+RW, etc.). Various types of digital memory cards compatible with certain embodiments of the invention include, but are not limited to, a secure digital (SD) memory card, Compact Flash™, Smart Media™, Memory Stick™, and the like.

In certain embodiments, the transmit unit of the host computer can transmit various data (e.g., the printer driver, the data of the print client, the printer driver information, the document data, the print job) and various signal (e.g., a polling request for the printer driver information and/or the device data, an instruction signal for start printing) from the host computer to the client computer, the management computer, the printer or other devices and can receive various data (e.g., the printer driver information, the device data, the document data, the print job) and various signal (e.g., a request signal for the data of the print client) from the client computer, the management computer, the printer or other devices. Examples of the transmit unit consistent with certain embodiments of the invention include, but are not limited to, a LAN adapter, a modem and a network card.

In certain embodiments, the display unit of the host computer can display various images and texts including the printer driver information and the data of the print client for the printer. Examples of the display unit consistent with certain embodiments of the invention include, but are not limited to, a liquid crystal display (LCD), a Braun tube, a cathode ray tube (CRT) and a plasma display panel.

2) A Client Computer

In certain embodiments, the client computer can produce the document data. The client computer can produce the print job based on the document data and transmit the print job to the printer. The printer driver, the application software and the OS can be installed in the client computer. Example of the client computer consistent with certain embodiments of the invention include, but are not limited to, a PC and a personal digital assistance (PDA). The client computer can comprise a processing unit, a storing unit, a display unit, an input unit and a transmit unit.

In certain embodiments, the processing unit of the client computer can control the entire client computer and/or the various units in the client computer. The processing unit can run various software including the OS, the application software and the printer driver. The processing unit can produce a document data to be printed using the application software. The processing unit can produce a print job based on the document data using the printer driver. The processing unit can process and/or calculate several data. Example of the processing unit consistent with certain embodiments of the invention include, but are not limited to, a CPU or a MPU with a memory and a software necessary for the processing.

In certain embodiments, the processing unit can specify what printer driver and/or OS is installed in the client computer and produce the printer driver information when the client computer receives a polling signal for requesting the printer driver information from the host computer. In certain embodiments, the processing section can produce the device data of the client computer when the client computer receives a polling signal for requesting the device data from the host computer. If the client computer has a print job for a certain printer when the client computer transmits the printer driver information to the host computer, the processing unit can make the client computer transmit the information about the print job also.

In certain embodiments, the storing unit of the client computer can store several software including the OS, the application software and the printer driver. In certain embodiments, the storing unit can store the application software for producing and transmitting the printer driver information responding to the polling request from the host computer. In certain embodiments, the storing unit can store several data including the document data, the device data, the printer driver information and the print job. Example of the storing unit consistent with certain embodiments of the invention include, but are not limited to, a hard disk, a memory (e.g., a RAM including NVRAM, M RAM, P RAM, Fe RAM, Flash RAM, and a ROM) and a removable data recording medium recorder/reader.

In certain embodiments, the display unit of the client computer can display various images including the document data. Examples of the display unit consistent with certain embodiments of the invention include, but are not limited to, a LCD, a Braun tube, a CRT and a plasma display panel.

In certain embodiments, the user can input various data (e.g. the document data), information, response or instruction (e.g., an instruction to start printing) to the client computer through the input unit of the client computer. Examples of the input unit consistent with certain embodiments of the invention include, but are not limited to, a keyboard, a mouse, a push button, a touch panel and a removable data recording medium reader.

In certain embodiments, the transmit unit of the client computer can transmit various data (e.g., the print job, the device data and the printer driver information) and various signal (e.g., an instruction signal for start printing) from the client computer to the host computer, the management computer, the printer or other devices and can receive various data and software (e.g., the printer driver) and various signal (e.g., a polling request for requesting the device data and/or the printer driver information) from the host computer, the management computer, the printer or other devices. Examples of the transmit unit consistent with certain embodiments of the invention include, but are not limited to, a LAN adapter, a modem and a network card.

3) A Printer

The printer can make a print corresponding to the print job sent to the printer. Examples of the printer consistent with certain embodiments of the invention include, but are not limited to, a laser beam printer (LBP), a multi function laser beam printer including copy function (MFP), an ink jet printer (IJP), a thermal printer (e.g., a dye sublimation printer) and a silver halide printer. The printer can be a color printer or a black and white (B/W) printer. In certain embodiments, the printer can comprise a processing unit, a print unit and a transmit unit. In certain embodiments, the printer can further comprise a storing unit and/or a display unit.

In certain embodiments, the processing unit of the printer can control the entire printer and/or the various units in the printer. The processing unit can decode and/or decompress the print job. The processing unit can rasterize the print job to produce the print data by which the print unit can print. In certain embodiments, the processing section can produce the device data of the printer when the printer receives a polling signal for requesting the device data from the host computer. Example of the processing unit consistent with certain embodiments of the invention include, but are not limited to, a CPU or a MPU (with a memory and a software for processing, if necessary) and an integrated circuit (IC), an application specific integrated circuit (ASIC), a field programmable gate array (FPGA) and a programmable logic device (PLD).

In certain embodiments, the print unit of the printer can print on a recording sheet according to the print job. For instance, the recording sheet can be a paper, OHP film and so on. Examples of the print unit consistent with certain embodiments of the invention include, but are not limited to, an image forming unit or a print engine for the laser beam MFP or the LBP, an ink jet head of the IJP and a thermal head of the thermal printer. In certain embodiments, the print engine or the image forming unit can comprise a laser beam scanning unit, a photo-sensitive drum (in other words, a photoconductor), a cleaning unit, an eraser lamp, a charging charger, a developing device, a transmit charger and so on. In certain embodiments, the image forming unit or the print engine for the color LBP, the color laser beam MFP can comprise one laser beam scanning unit and several imaging units corresponding to each color of C (cyan), M (magenta), Y (yellow) and K (black) and comprising the photo-sensitive drum, the cleaning unit, the eraser lamp, the charging charger, the developing device, the transmit charger and so on.

In certain embodiments, the transmit unit of the printer can transmit various data (e.g., the device data) and various signal from the printer to the client computer, the host computer, the management computer or other devices and can receive various data (e.g., the print job, the document data) and various signal (e.g., the polling request for the device data, the instruction to start to print) from the client computer, the host computer, the management computer or other devices. Examples of the transmit unit consistent with certain embodiments of the invention include, but are not limited to, a LAN adapter, a modem and a network card.

In certain embodiments, the storing unit can store the device data. Example of the storing unit consistent with certain embodiments of the invention include, but are not limited to, a hard disk and a memory (e.g., a RAM including NVRAM, M RAM, P RAM, Fe RAM, Flash RAM, and a ROM).

In certain embodiments, the display unit of the printer can display various condition, information or instruction. Examples of the display unit consistent with certain embodiments of the invention include, but are not limited to, a LCD.

4) A Management Computer

In certain embodiments, the management computer can instruct to display the print client for the specified printer and display the print client. In certain embodiments, only authorized person (e.g., IT (information technology) management person) can use the management computer and can check the print client from the management computer. Example of the management computer consistent with certain embodiments of the invention include, but are not limited to, a PC. The management computer can comprise a processing unit, a storing unit, a display unit, an input unit and a transmit unit.

In certain embodiments, the processing unit of the management computer can control the entire management computer and/or the various units in the management computer. The processing unit can run various software including the OS, the application software and the printer driver. The processing unit can process and/or calculate several data. The processing unit can authorize only specific person to operate the management computer. In certain embodiments, the processing unit can authorize the user to use the management computer by judging whether the password and/or ID input in the management computer by the user is correct password and/or ID or not. In certain embodiments, the processing unit can judge the input password and/or ID is correct when the input password and/or ID is identical with the password and/or ID stored in the storing unit. Example of the processing unit consistent with certain embodiments of the invention include, but are not limited to, a CPU or a MPU with a memory and a software necessary for the processing and authorizing.

In certain embodiments, the processing unit can produce a request signal to request the data of the print client to the host computer when the IT management person instructs to display the data of the print client for the printer on the management computer. In certain embodiments, the processing unit can make the display unit display an icon for requesting the data of the print client for the specified printer.

In certain embodiments, the storing unit of the management computer can store various software including the OS, the application software and the printer driver. In certain embodiments, the storing unit can store the application software for displaying an icon for requesting the data of the print client for the specified printer and producing the request signal to request the data of the print client to the host computer. In certain embodiments, the storing unit can store several data (e.g., the correct password, the correct ID, the document data, the data of the print client, the printer driver information and the device data). Example of the storing unit consistent with certain embodiments of the invention include, but are not limited to, a hard disk, a memory (e.g., a RAM including NVRAM, M RAM, P RAM, Fe RAM, Flash RAM, and a ROM) and a removable data recording medium recorder/reader.

In certain embodiments, the display unit of the management computer can display various images including the document data, the data of the print client, the printer driver information. Examples of the display unit consistent with certain embodiments of the invention include, but are not limited to, a LCD, a Braun tube, a CRT and a plasma display panel.

In certain embodiments, the authorized person can input various data, information (e.g., correct password, correct ID), response or instruction (e.g., an instruction to start printing, and an instruction to display the data of the print client for the specified printer) to the management computer through the input unit of the management computer. Examples of the input section consistent with certain embodiments of the invention include, but are not limited to, a keyboard, a mouse, a push button, a touch panel and a removable data recording medium reader.

In certain embodiments, the transmit unit of the management computer can transmit various data (e.g., the device data) and various signal (e.g., a request signal of the data of the print client, an instruction signal for start printing) from the management computer to the host computer, the client computer, the printer or other devices and can receive various data (e.g., the data of the print client and the printer driver information) and various signal from the host computer, the client computer, the printer or other devices. Examples of the transmit unit consistent with certain embodiments of the invention include, but are not limited to, a LAN adapter, a modem and a network card.

### EXAMPLE

One example of the printing system is described in the following. This invention is not limited to the following example.

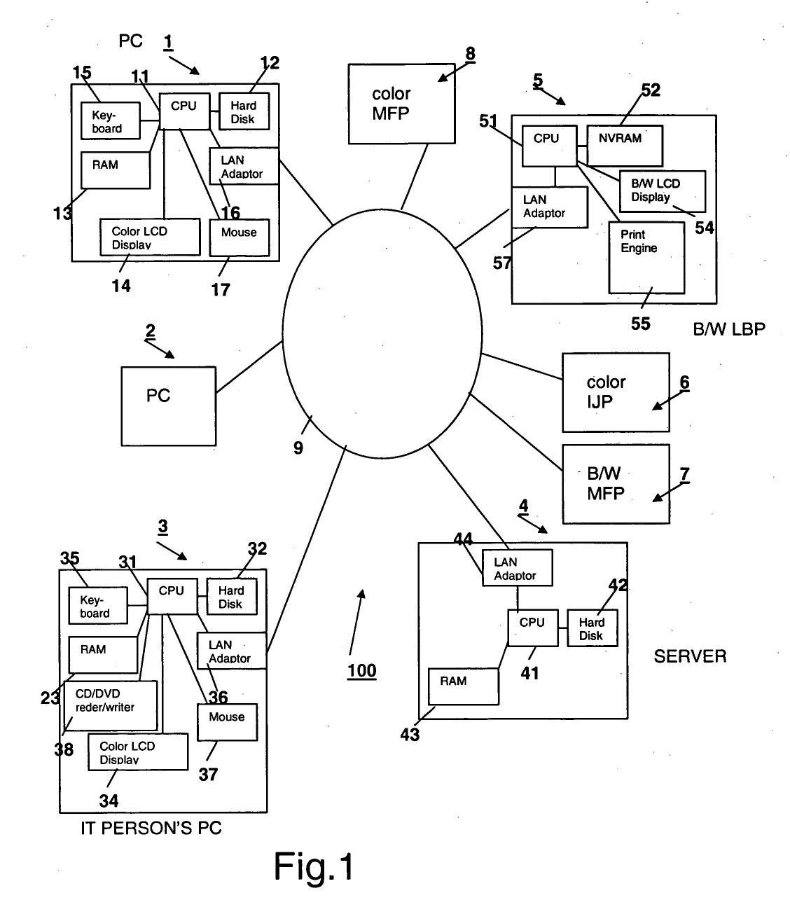

In certain embodiments, as illustrated in FIG. 1, the printing system (e.g., a printing system 100) can comprise two clients computer (e.g., a PC 1, a PC 2), a management computer (e.g., an IT person's PC 3), a host computer (e.g., a server 4), four printers (e.g., a B/W LBP 5, a color IJP 6, a B/W MFP 7, a color MFP 8) and a network (e.g., LAN 9) connecting the PC 1, PC 2, the IT person's PC 3, the B/W LBP 5, the color IJP 6, the B/W MFP 7 and the color MFP 8.

As illustrated in FIG. 1, the PC 1 can comprise a processing unit (e.g., a CPU 11 and a RAM 13 with necessary software for processing), an input unit (e.g., a mouse 17 and a keyboard 15), a storing unit (e.g., the RAM 13 and a hard disk 12), a display unit (e.g., a color LCD display 14) and a transmit unit (e.g., a LAN adaptor 16).

The IT person's PC 3 can comprise a processing unit (e.g., a CPU 31 and a RAM 33 with necessary software for processing and authorizing), an input unit (e.g., a CD/DVD reader/writer 38, a mouse 37 and a keyboard 35), a storing unit (e.g., the RAM 33 and a hard disk 32), a display unit (e.g., a color LCD display 34) and a transmit unit (e.g., a LAN adaptor 36).

The server 4 can comprise a processing unit (e.g., a CPU 41 and a RAM 43 with necessary software for processing), a storing unit (e.g., the RAM 43 and a hard disk 42) and a transmit unit (e.g., a LAN adaptor 46).

The B/W LBP 5 can comprise a print unit (e.g., a print engine 55), a processing unit (e.g., a CPU 51 and a NVRAM 52 with necessary software for processing), a storing unit (e.g., the NVRAM 52), a display unit (e.g., a B/W LCD display 54) and a transmit unit (e.g., a LAN adaptor 57).

The OS and the application software (e.g., Microsoft Word, Adobe Photoshop and the like) recorded on a CD-ROM can be installed in the PC 1, the PC2, the IT person's PC 3 and the server 4. An application software for producing a request signal for requesting to display the data of the print client for each of the printers and for displaying an icon for requesting to display the data of the print client can be installed in the IT person's PC 3. And, an application software for replying to the request signal sent from the IT person's PC 3 can be installed in the server 4. Although the OS and the printer driver software are not necessary to be modified so that the icon for requesting to display the data of the print client can be displayed in this example, the OS and/or the printer driver can be modified so that the icon can be displayed.

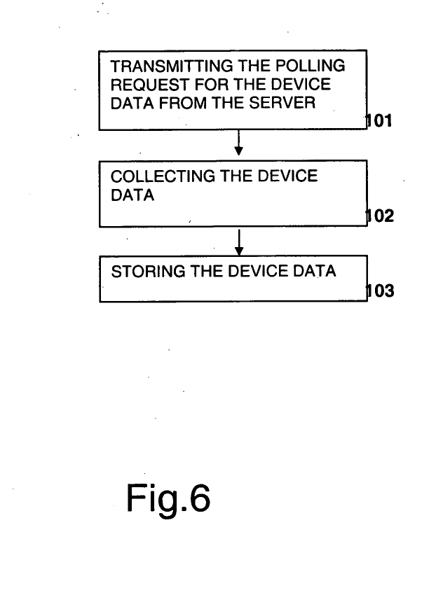

First of all, the server 4 collects the device data of each device included in the printing system 100. The CPU 41 of the server 4 can produce the polling request for requesting the device data and the polling request can be transmitted from the LAN adaptor 44 to the PC 1, the PC 2, the IT person's PC 3, the B/W LBP 5, the color IJP 6, the B/W MFP 7 and the color MFP 8 (101 of FIG. 6). After receiving the polling request from the server 4, each of the PC 1, the PC 2, the IT person's PC 3, the B/W LBP 5, the color IJP 6, the B/W MFP 7 and the color MFP 8 can reply to the server by transmitting the device data (e.g., the name of the device, the manufacturer of the device and the category of the device) stored in the storing section of each device to the server 4 (102 of FIG. 6). After receiving the device data of each device in the printing system 100, the hard disk 42 of the server 4 can store the device data transmitted from each device (103 of FIG. 6). In another example, the device such as the client computer or the printer can voluntary transmit the device data to the server when the print job or other data is transmitted from the device.

The device data stored in the hard disk 42 of the server 4 in this example is shown in Table 1.

TABLE 1

DEVICE DATA

| DEVICE | MANUFACTURER | NAME | CATEGORY |
|---|---|---|---|
| PC 1 | DEXX | SED-5000 | PC |
| PC 2 | IBC | TG-X | PC |
| IT PERSON'S PC 3 | NEG | SAF-80B | PC |
| PRINTER 5 | KM | BWX-7250 | B/W LBP |
| PRINTER 6 | A | AX | COLOR IJP |
| PRINTER 7 | B | BF | B/W MFP |
| PRINTER 8 | KM | CCX-2050 | COLOR MFP |

The printer driver for the B/W LBP 5 and the B/W MFP 7 is stored in the hard disk 42 of the server 4. If the PC 1, the PC 2 or the IT person's PC 3 instructs to start printing utilizing the B/W LBP 5 or the B/W MFP 7 for the first time, the server 4 can transmit the printer driver for the B/W LBP 5 or the B/W MFP 7 to the PC instructing to start printing and the printer driver can be downloaded to the PC.

In this example, the current situation is as shown in Table 2.

TABLE 2

| PC | DOWNLOADED PRINTER DRIVER |
|---|---|
| PC 1 | FOR B/W LBP 5 (ver. 1) |
| | FOR B/W MFP 7 (ver. 1) |
| PC 2 | — |
| IT PERSON'S PC 3 | FOR B/W LBP 5 (ver. 1) |

When the printer driver is downloaded from the server 4 to the PC 1, the PC 2 or the IT person's PC, the hard disk 42 of the server 4 can store the information about what printer driver is downloaded to the PC 1, the PC 2 or the IT person's PC 3. Namely, the printer driver information in Table 2 can be already stored in the hard disk 42 of the sever 4. The CPU 41 of the server 4 can produce the data of the print client based on the printer driver information and the device data stored in the hard disk 42 as shown in Table 3. By doing that, the server 4 can decide which client computer and/or the management computer is a print client for the printer.

TABLE 3

| | PRINT CLIENT FOR THE PRINTER |
|---|---|
| PRINTER | (version of the printer driver) |
| BWX-7250 (B/W LBP 5) | PC 1 (ver. 1), PC 3 (ver. 1) |
| BF (B/W MFP 7) | PC 1 (ver. 1) |

The current print clients for the B/W LBP 5 are the PC 1 and the PC 3. The current print client for the B/W MFP 7 is the PC 1. If the PC 2 instructs to start printing utilizing the B/W MFP 7 later, the printer driver (ver. 1) for the B/W MFP 7 can be downloaded from the server 4 to the PC 2 and the PC 2 can be the print client for the B/W MFP 7.

On the other hand, the printer driver for the color IJP 6 and the color MFP 8 can be installed to the PC 1, the PC 2 or the IT person's PC 3 by reading a CD-ROM recording the printer driver by the inputting device (e.g., the CD/DVD reader/writer 38) of the PC 1, the PC 2 or the IT person's PC 3.

In this example, the current situation is as shown in Table 4.

TABLE 4

| PC | INSTALLED PRINTER DRIVER |
|---|---|
| PC 1 | FOR COLOR IJP 6 (ver. 2) |
| PC 2 | FOR COLOR IJP 6 (ver 1) |
| | FOR COLOR MFP 8 (ver 1) |
| IT PERSON'S PC 3 | FOR COLOR IJP 6 (ver. 1) |
| | FOR COLOR MFP 8 (ver. 2) |

The following described how to obtain and display the data of the print client.

The user (e.g., IT management person) who instructs to display the data of the print client needs to be authorized to use the IT person's PC 3. First of all, the IT person's PC 3 is turned on. Then, the CPU 31 of the IT person's PC can request to input the password and ID of the user by showing the request message on the color LCD display 34. A correct password and ID can be stored in the hard disk 32 beforehand.

If the user inputs the password and ID with the keyboard 35 and the mouse 37 to the IT person's computer 3, the CPU 31 can judge whether the input password and ID is correct or not by comparing the input password and ID with the correct password and ID stored in the hard disk 32.

If the CPU 31 judges the input password and ID is identical with the password and ID stored in the hard disk 32 and the input password and ID are correct, the CPU 31 can authorize the user to use and access the IT person's PC 3. On the other hand, if the CPU 31 judges the input password and ID is different from the password and ID stored in the hard disk 32 and the input password and ID are not correct, the CPU 31 can prohibit the user from using and accessing the IT person's PC 3.

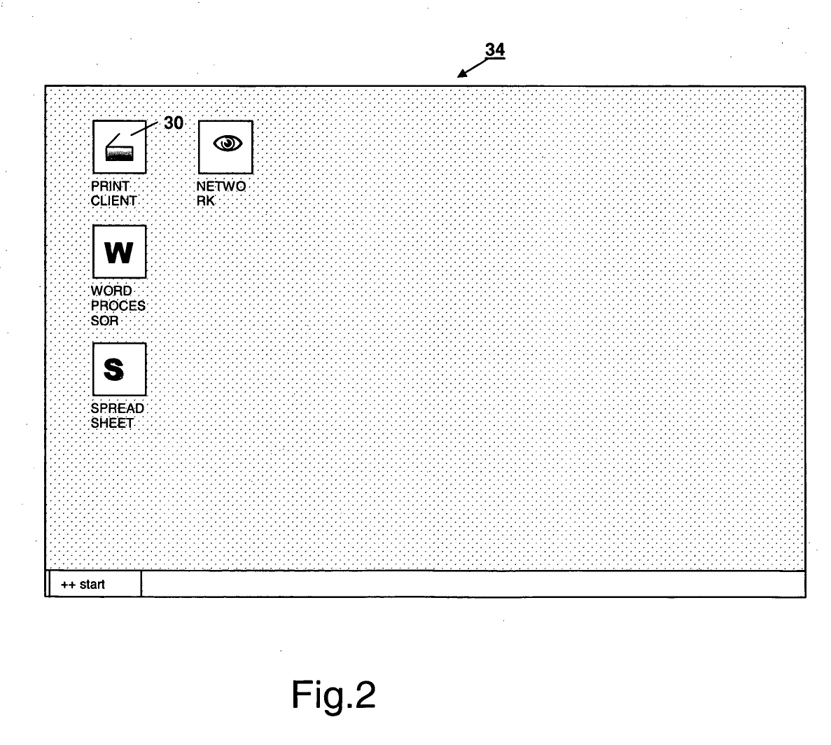

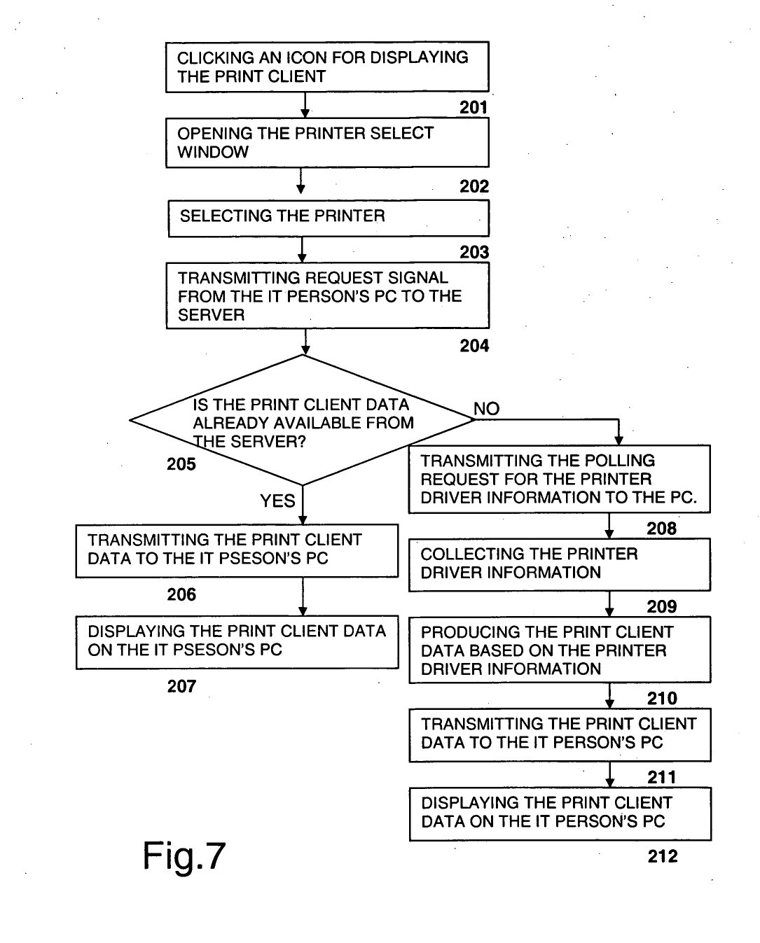

The application software for displaying the icon for requesting the data of the print client can be stored in the hard disk 32 of the IT person's PC 3 and the application software can run in the IT person's PC 3. As illustrated in FIG. 2, the color LCD display 34 can display the icon 30 for requesting to display the data of the print client. After the IT management person is authorized to use the IT person's PC 3, he or she can click the icon 30 using the keyboard 35 or the mouse 37 (201 of FIG. 7).

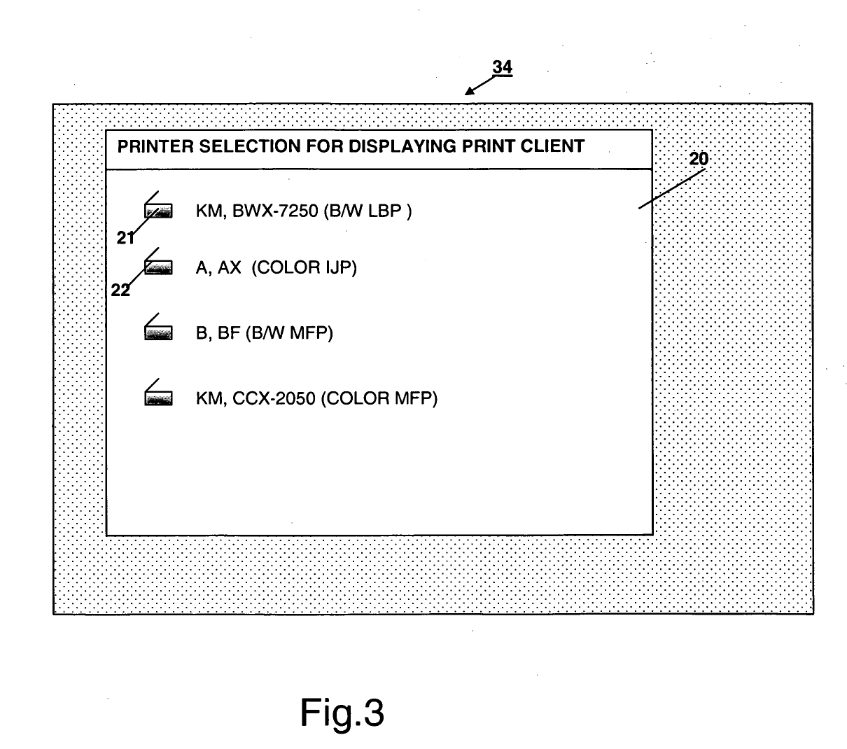

If the icon 30 is clicked, a printer selection window 20 can be displayed on the color LCD display 34 according to the application software running on the CPU 31 as shown in FIG. 3. (202 of FIG. 7) The printer selection window 20 can comprise several icons 21, 22 each of which is corresponding to each printer included in the printing system 100. Utilizing the mouse 36 and the keyboard 35, the IT management person can click an icon 21, 22 in the printer selection window 20 corresponding to the printer of which print client he or she wants to know. (203 of FIG. 7)

If the IT management person clicks the icon 21 corresponding to the B/W LBP 5, the CPU 31 of the IT person's PC 3 can produce a request signal for requesting the data of the print client for the B/W LBP 5 according to the application software stored in the hard disk 32. The request signal can be transmitted from the LAN adaptor 36 to the server 4 via the LAN 9. (204 of FIG. 7) As described in the Table 3, the hard disk 42 of the server 4 already stores the data of the print client for the B/W LBP 5. (205 of FIG. 7) Therefore, without transmitting the polling request for the printer driver information from the server 4, the data of the print client for the B/W LBP 5 in Table 3 can be transmitted from the LAN adaptor 44 of the server 4 to the IT person's PC 3 via the LAN 9. (206 of FIG. 7)

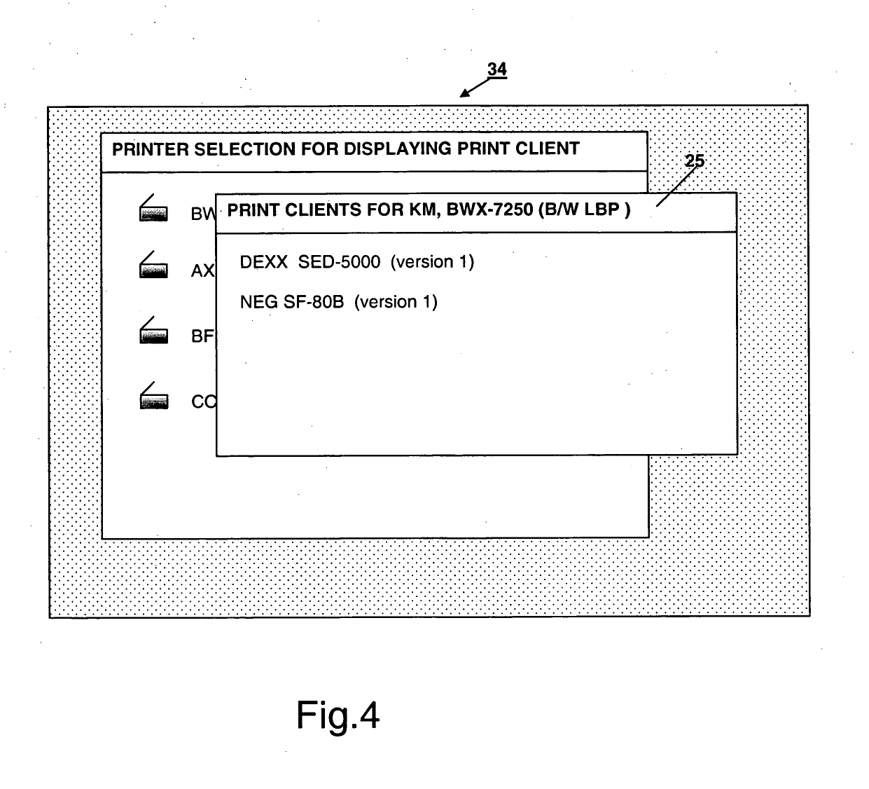

After receiving the data of the print client for the B/W LBP 5, the color LCD display 34 of the IT person's PC can display a print client window 25 showing the data of the print client for the B/W LBP 5 and the version of the printer driver as illustrated in FIG. 4. In this example, the print clients for the B/W LBP 5 (KM, BWX-7250) are the PC 1 (DEXX, SED-5000) and the IP person's PC 3 (NEG, SF-80B).

Next, if the IT management person clicks the icon 22 corresponding to the color IJP 6, the CPU 31 of the IT person's PC 3 can produce a request signal for requesting the data of the print client for the color IJP 6 according to the application software stored in the hard disk 32. The request signal can be transmitted from the LAN adaptor 36 to the server 4 via the LAN 9. (204 of FIG. 7) Different from the data of the print client for the B/W LBP 5, the data of the print client for the color IJP 6 is not stored in the hard disk 42 of the server 4. (205 of FIG. 7)

Therefore, after the server 4 receives the request signal for the data of the print client from the IT person's PC 3, the CPU 41 of the server 4 can produce a polling request for requesting a printer driver information for the color IJP 6 according to the application software stored in the hard disk 42. The polling request can be transmitted from the LAN adaptor 44 to the PC 1, the PC 2 and the IT person's PC via the LAN 9. (208 of FIG. 7)

Each of the PC 1, the PC 2 and the IT person's PC can receive the polling request for the printer driver information for the color IJP 6 from the server 4. Then, each of the PC 1, the PC 2 and the IT person's PC can transmit the printer driver information for the color IJP 6 to the server 4. (209 of FIG. 7) Also, when the PC 1 receives the polling request, the PC 1 has a print job for the color IJP 6. In that case, the PC 1 can also transmit that the PC 1 is the active print client for the color IJP 6 to the server 4. The server 4 can collect the printer driver information for the color IJP 6 including the information about which PC is an active print client, and the hard disk 42 can store the printer driver information for the color IJP 6 and the information about the active print client as shown in Table 5.

TABLE 5

| | INSTALLED PRINTER DRIVER |
|---|---|
| PC | FOR COLOR IJP 6 |
| PC 1 (ACTIVE) | VERSION 2 |
| PC 2 | VERSION 1 |
| IT PERSON'S PC 3 | VERSION 1 |

In another example, not only the printer driver information for the color IJP 6 but also printer driver information for any other printers can be collected by the server.

After collecting the printer driver information, the CPU 41 of the server 4 can produce the data of the print client as shown in Table 6 based on the printer driver information and the information about the active print client transmitted from the PC 1, the PC 2 and the IT person PC 3 and the device data stored in the hard disk 42. (210 of FIG. 7) By doing that, the server 4 can decide which client computer and/or the management computer is a print client for the printer.

TABLE 6

| | PRINT CLIENT FOR THE PRINTER |
|---|---|
| PRINTER | (version of the printer driver) |
| AX (color IJP 6) | PC 1 (active)(ver. 2), PC 2 (ver. 1), |
| | IT person's PC 3 (ver. 1) |

The data of the print client for the color IJP 6 can be transmitted from the LAN adaptor 44 to the IT person's PC 3 via the LAN 9. (211 of FIG. 7)

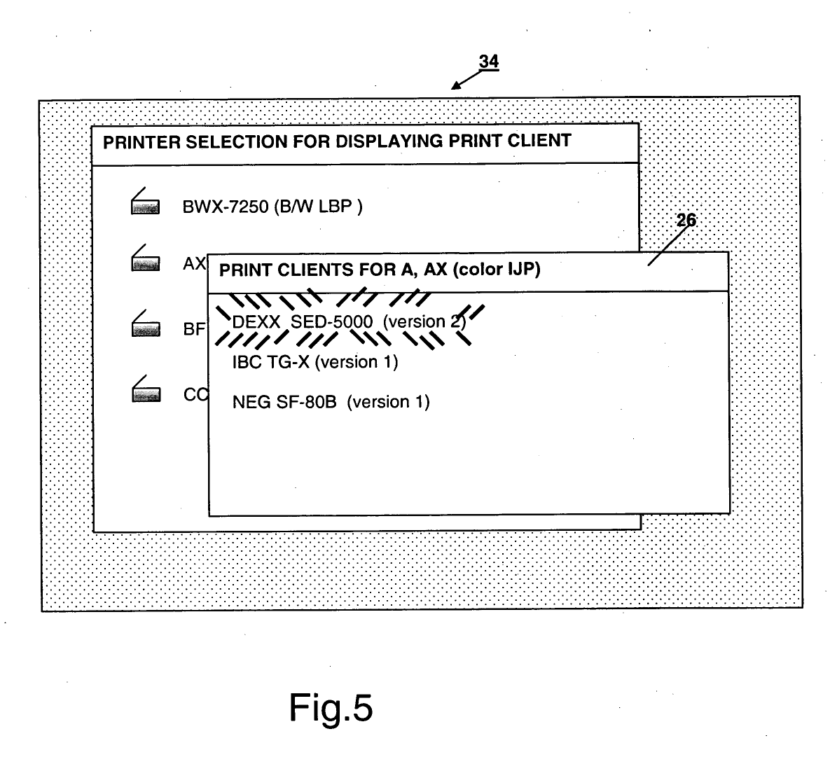

After receiving the data of the print client for the color IJP 6, the color LCD display 34 of the IT person's PC can display a print client window 26 showing the data of the print client for the color IBP 6 and the version of the printer driver as illustrated in FIG. 5. (212 of FIG. 7) In this example, the print clients for the color IJP 6 (A, AX) are the PC 1 (DEXX, SED-5000), the PC 2 (IBC, TG-X) and the IP person's PC 3 (NEG, SF-80B). Also, the text of the DEXX, SED-5000 which is the active print client can blink in the print client window 6 to show the PC 1 is the active print client.

In another example, any other information (e.g., the current status of the print client and/or the printer) regarding the print client can be displayed in addition to the information of the version of the printer driver. In another example, the information of the OS installed in the PC 1, PC 2 and the IT person's PC 3 can be collected by the server 4 as one of the printer driver information.

For instance, after looking the print client window for the color IJP 6, the IT management person can send an e-mail to the user of the PC 2 informing that a version 2 of the printer driver for the color IJP 6 is already bought. The IT management person can easily identify the user to whom the IT management person should inform the version change of the printer driver by checking the print clients on the IT person's PC 3. Also, if the color IJP 6 is disconnected from the printing system 100, the IT management person can send an e-mail to the user of the PC 1 and the PC 2 informing that the color IJP 6 cannot be used. In this case, the IT management person can easily identify the user of the color IJP 6 to whom the IT management person should inform the disconnection of the color IJP 6.

Other various embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A printing system comprising:
at least one printer,
several client computers in which printer driver for the printer and the operating system are installed,
a host computer, and
a display unit,
wherein the printer, the client computers, the host computer and the display unit are connected via a network,
wherein the host computer collects printer driver information about what printer driver and/or operating system are installed in the client computers from the client computers,
wherein the host computer decides which client computer is a print client for the printer based on the printer driver information, and
wherein the display unit displays the print client for the printer.

2. The printing system of claim 1, wherein the printing system further comprises a management computer comprising the display unit.

3. The printing system of claim 1, wherein the host computer comprises the display unit.

4. The printing system of claim 1, wherein the display unit displays the printer driver information.

5. A printing system comprising:
at least one printer,
several client computers in which printer driver for the printer and the operating system are installed,
means for collecting printer driver information about what printer driver and/or operating system is installed in the client computers from the client computers,
means for deciding which client computer is a print client for the printer based on the printer driver information,
means for displaying the print client for the printer, and
wherein the printer and the client computers are connected via a network.

6. A removable data recording medium that stores instructions, which when executed by a host computer perform steps in a method for representing configuration options available on devices in a printing system comprising the host computer, a client computer and a printer, the steps comprising:
transmitting a polling request to request printer driver information about what printer driver and/or operating system is installed in the client computer to the client computer,
receiving the printer driver information from the client computer,
deciding which client computer is a print client for the printer based on the printer driver information,
transmitting the data of the print client to a display unit to display the print client for the printer.

7. A host computer included in a printing system comprising a printer, client computers, the host computer comprising;
a processing unit which produces a polling request to request printer driver information about what printer driver and/or operating system is installed in the client computer,
a transmit unit which transmits the polling request to the client computer and receives the printer driver information from the client computer,
a processing unit which decides which client computer is a print client for the printer based on the printer driver information,
a display unit which displays the print client for the printer.

8. A host computer included in a printing system comprising a printer, client computers, the host computer comprising;
a processing unit which produces a polling request to request printer driver information about what printer driver and/or operating system is installed in the client computer,
a transmit unit which transmits the polling request to the client computer and receives the printer driver information from the client computer,
a processing unit which decides which client computer is a print client for the printer based on the printer driver information, and
wherein the transmit unit transmits the data of the print client to a display unit included in the printing system to make the display unit display the print client for the printer.
